(19) United States
(12) Patent Application Publication
(10) Pub. No.: US 2008/0309589 A1
(43) Pub. Date: Dec. 18, 2008

(54) Segmented Electroluminescent Device for Morphing User Interface

(76) Inventor: Joseph M. Morales, Palatine, IL (US)

Correspondence Address: PHILIP H. BURRUS, IV, 460 Grant Street, Atlanta, GA, 30312, US

(21) Appl. No.: 11/762,481

(22) Filed: Jun. 13, 2007

(51) Int. Cl. G09G 3/12; H04B 1/38

(52) U.S. Cl. 345/36; 455/566

(57) ABSTRACT

A dynamic user interface (1000) is configured to present one of a plurality of keypad configurations to a user. Each keypad configuration includes a plurality of user actuation targets that may be selectively presented to, or hidden from, a user. A segmented optical shutter (204) having segments (801,802,803,804) configured for selective transition from opaque to translucent states is disposed above an segmented optical shutter (204) having a plurality of transparent electrodes (901), each operating as an electroluminescent element. When each segment (801) is active and in a transparent state, a corresponding electroluminescent element is actuated so as to project light (1001,1002) both through the corresponding segment (801) at a first luminosity and about the corresponding segment (801) at a second luminosity, so as to circumscribe the segment (801). The illuminated segment (801) and the circumscription (1004) together form a user actuation target.

### BACKGROUND

1. Technical Field

This invention relates generally to electronic devices having user interfaces, and more particularly to an electronic device having a backlit user interface, such as a keypad, that may be selectively configured to present a variety of device-mode-based keypad configurations to a user, where each configuration includes illuminated actuation targets.

2. Background Art

Portable electronic devices, such as radiotelephones, are becoming more and more popular. According to some estimates, over two billion mobile telephones are in use across the world today. As more people come to use mobile devices, designers and engineers are creating devices that integrate more and more features. For instance, many mobile telephones today also include digital camera functions and text messaging functions. Some even include music playback functions.

One issue associated with the integration of new features and functionality with devices like mobile telephones involves the user interface. Traditional mobile telephones only included twelve to fifteen keys. These keys included the standard 12-digit telephone keypad, along with a “send” key and an “end” key. Such devices are sometimes not compatible with new features and functions as new modes of operation require new, dedicated keys or input devices in addition to the basic phone keys. Further, the devices may also require additional keys for the purpose of navigation or initiation of the modes within the device.

One solution to the need for more keys in the user interface is to simply add more buttons to the device. Some devices, for example, include full keypads with forty to fifty keys. The problem with this solution is that many mobile devices, including mobile telephones, are getting smaller and thinner. When many keys are clustered in one location, the likelihood of user confusion or difficulty with operation of the device increases. What's more, in a particular mode, many of the keys are not needed. For example, when a device is in a camera mode, the number keys 1-9 are generally not needed to take pictures.

A further problem associated with user interfaces involves visibility. It is desirable to be able to see user interfaces in both low-light and bright-light environments. When device user interfaces are crowded with many keys, each key is generally configured to be as small as possible while still permitting acceptable usage characteristics. The typical way to illuminate a user interface is with a backlight, where a light behind the keys projects through the keys. As the keys get smaller and are placed more closely together, the surface area of each key through which light may pass becomes smaller. This results in less visible user interface in low-light conditions.

Thus there is a need for an improved user interface for electronic devices that provides a plurality of user interfaces, where each interface includes keys required for a particular mode of operation, and which exhibits good visibility in both low-light and bright-light conditions.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments in accordance with the present invention.

FIG. 1 illustrates an electronic device having a shutter enabled dynamic keypad in accordance with one embodiment of the invention.

FIG. 2 illustrates an exploded view of one embodiment of a dynamic keypad interface in accordance with the invention.

FIG. 3 illustrates a sectional view of one embodiment of a dynamic keypad interface in accordance with the invention.

FIG. 4 illustrates one embodiment of a capacitive sensor in accordance with the invention.

FIG. 5 illustrates one embodiment of a proximity sensor in accordance with the invention.

FIG. 6 illustrates an exploded view of a twisted nematic liquid crystal display in accordance with one embodiment of the invention.

FIG. 7 illustrates an optical shutter in the opaque state in accordance with one embodiment of the invention.

FIG. 8 illustrates an exemplary segmented optical shutter having sample shutters open, or in the translucent state, in accordance with the invention.

FIG. 9 illustrates a segmented electroluminescent device in accordance with one embodiment of the invention.

FIG. 10 illustrates one embodiment of an electroluminescent device coupled to a segmented optical shutter in accordance with the invention.

FIG. 11 illustrates one embodiment of a resistive layer in accordance with the invention.

FIG. 12 illustrates one embodiment of a substrate layer in accordance with the invention.

FIG. 13 illustrates one embodiment of a tactile feedback layer in accordance with the invention.

FIG. 14 illustrates a perspective view of an assembled dynamic keypad interface in accordance with one embodiment of the invention.

FIG. 15 illustrates a perspective view of an assembled dynamic keypad interface being inserted into an electronic device in accordance with one embodiment of the invention.

FIG. 16 illustrates a resistive switch sensing area in accordance with one embodiment of the invention.

FIG. 17 illustrates a capacitive switch sensing area in accordance with one embodiment of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF THE INVENTION

Embodiments of the invention are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Relational terms such as first and second, top and bottom, and the like may be used solely to distinguish one entity or action from another entity or action without necessarily requiring or implying any actual such relationship or order between such entities or actions. Also, reference designators shown herein in parenthesis indicate components shown in a figure other than the one in discussion. For example, talking about a device (10) while discussing figure A would refer to an element, 10, shown in figure other than figure A.

It will be appreciated that embodiments of the invention described herein may be comprised of one or more conventional processors and unique stored program instructions that control the one or more processors to implement, in conjunction with certain non-processor circuits, some, most, or all of the functions of a backlit, morphing display with user actuation targets presented as lighted buttons as described herein. The non-processor circuits may include, but are not limited to, a radio receiver, a radio transmitter, signal drivers, clock circuits, power source circuits, and user input devices. It is expected that one of ordinary skill, notwithstanding possibly significant effort and many design choices motivated by, for example, available time, current technology, and economic considerations, when guided by the concepts and principles disclosed herein will be readily capable of generating such circuits, or software instructions and associated programs, with minimal experimentation.

Commonly assigned, co-pending U.S. patent application Ser. No. 11/684,454, filed Mar. 9, 2007, which is incorporated herein by reference, teaches a morphing keypad for an electronic device that is configured to present a plurality of actuation targets to a user by opening and closing segmented shutters in an optical shutter layer. One embodiment of such an optical shutter layer uses a twisted nematic liquid crystal layer that is transparent when a shutter is open and is opaque when the shutter is closed. Depending upon the type of optical shutter being used, and the color configurations of filters and other associated components, the opaque state can be configured to be less than perfectly non-transparent. In other words, the opaque state can be configured to be one where small amounts of light pass through. Embodiments of the present invention take advantage of this semi-transparent state to present a lighted virtual button about the segments of the optical shutter to provide a user an easily visible, easily accessible user actuation target.

The optical shutter layer described herein is used as a morphing interface assembly for a portable electronic device, such as a mobile telephone. The interface includes a cover layer, which may be plastic or glass, for protecting the interface. In one embodiment, a capacitive sensor layer is disposed beneath the cover layer. The capacitive sensor layer is configured to be a “proximity detector” to detect the presence of an object, such as a user's finger, near to or touching the user interface. The capacitive sensor layer may optionally be configured to determine the positional location of an object along the device as well.

The segmented optical shutter layer, which in one embodiment is a low-resolution, twisted nematic liquid crystal display, is disposed beneath the cover layer and is configured to present multiple interface configurations to a user. By opening and closing geometrically specific “shutters”, the optical shutter layer may present a plurality of mode-base keypad configurations along a keypad region of the device. The shutters in the low-resolution display are selectively operable segments that are configured to transition between an opaque state and a translucent (essentially a transparent) state, thereby revealing and hiding user actuation targets. In one embodiment, the user actuation targets are each geometrically configured as one of alphanumeric characters, symbols, or combinations of both. Examples of symbols include a photo capture symbol, a call send symbol, a call end symbol, a play symbol, a record symbol, a pause symbol, a forward symbol, and a reverse symbol.

Embodiments of the present invention simplify the overall user input of the device. By way of example, while a shutter in the optical shutter may include a window configured as “4 ghi”, an electroluminescent device may then be configured to both project light through the window and about the window—through the optical shutter layer—so as to present a haloed virtual key about the “4 ghi” characters. Said differently, the electroluminescent device projects through the translucent segment at a first luminosity, and about the segment, in the geometric shape of a conventional key, at a second luminosity. The result is a bright “4 ghi” and a slightly dimmer key—which may be oval in shape—about the “4 ghi”.

As the optical shutter may be configured in a variety of ways, in one embodiment the keypad configurations are limited to only the keys necessary for either the current mode of operation or for navigation between the multiple modes. Electrical impulses, which are applied to specially shaped, translucent electrodes, enable key graphics or icons to be selectively opened or closed, i.e. turned on or off, to match the operating mode of the device.

When the optical shutter device is in the off state, in one embodiment, it is in an opaque state. The optical shutter therefore effectively prohibits light from being transmitted into, or out of, the device. The term “effectively” is used because in some embodiments the optical shutter layer is not perfectly non-transparent. It is opaque in that it may allow some light through, but not enough, for example, for an image to be seen. The present invention takes advantage of this non-perfect light absorption to present virtual keys to a user.

To actuate, in certain situations, the electroluminescent layer and the optical shutter, a capacitive senor layer may be employed. The capacitive sensor layer, in one embodiment, enables proximity sensing. The capacitive sensor layer may be used for proximity sensing to determine when the device is about to be touched. Such sensing may be employed to wake the device from an idle mode.

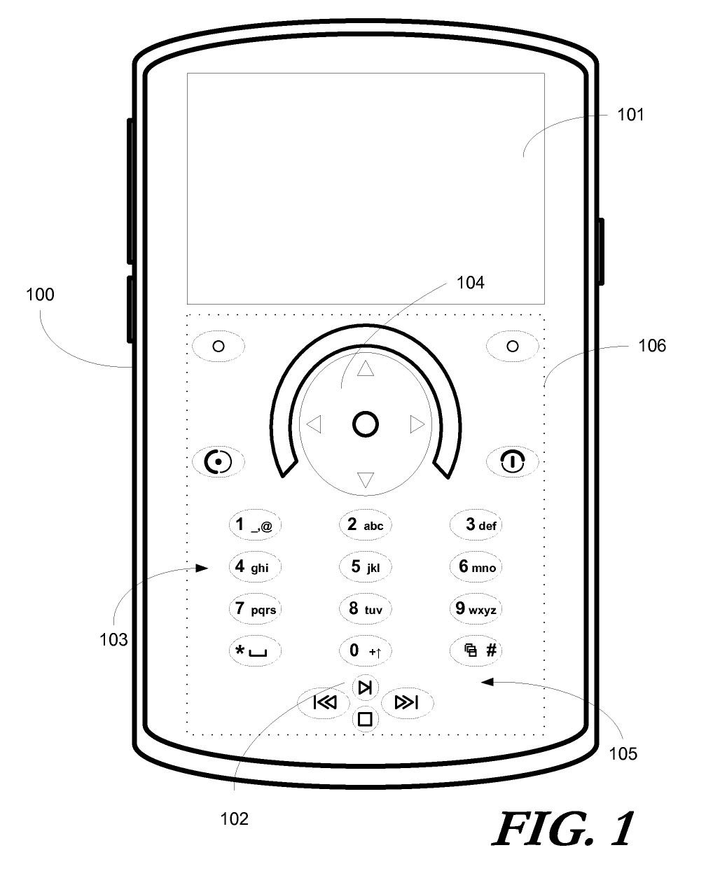

Turning now to FIG. 1, illustrated therein is portable electronic device 100 comprising a high-resolution display 101 and low-resolution display that is configured as a segmented optical shutter 102. The segmented optical shutter 102 is configured to present a mode-based dynamic keypad 103 to a user. The exemplary embodiment shown in FIG. 1 also includes a continually accessible navigation device 104, disposed adjacent to the high-resolution display 101 and the segmented optical shutter 102, which is used, among other things, for navigating among different modes of the device 100.

The high-resolution display 101, which in one embodiment is a liquid crystal display (LCD), is configured to present device information to the user. The term “high-resolution display” is used herein to refer to a device that can present text and images to a user by altering a large number of pixels which, when viewed collectively by a user, form the presented text or image. The high-resolution display 101 is used for the presentation of text, information, and graphics on a mobile device with sufficient granularity as to be easily switched between graphics or text. For example, the high-resolution display 101 would be one suitable for presenting an image in the Joint Photographics Expert Group (JPG) format to the user. Such displays generally are configured to turn on and off individual pixels by way of a display driver for the presentation of high-resolution information. Examples include a 256 pixel by 128 pixel reflective or backlit LCD. Exemplary high-resolution display devices are manufactured by Samsung and Sony.

The front surface 105 of the device 100 forms the overall user interface. In a keypad region 106, the segmented optical shutter 102 provides a dynamic user input interface. This dynamic user interface is configured to present different indicators, which may appear as keys or actuation targets, across the user interface in the keypad region 106.

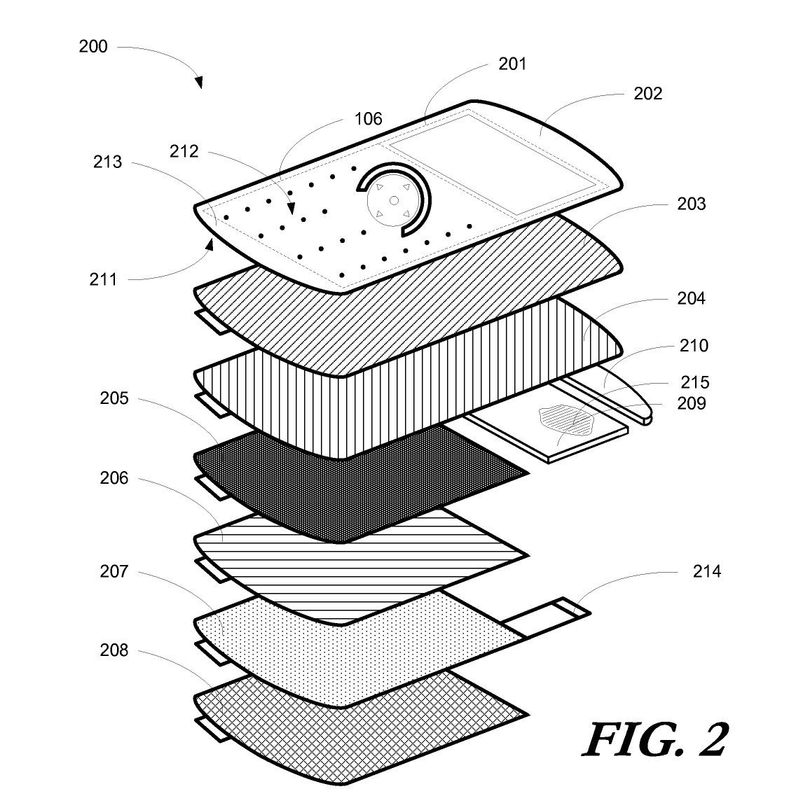

Turning now to FIG. 2, illustrated therein is an exploded view of a dynamic user interface 200 for a portable electronic device (100) in accordance with one embodiment of the invention. The user interface 200 includes a dynamic keypad region 106 and a display region 201 atop the display. The user interface 200 is made from several layers, each layer implementing a different function. While several layers are shown, it will be clear to those of ordinary skill in the art having the benefit of this disclosure that each and every layer may not be required for a specific application. By way of example, the capacitive sensor 203 may not be needed for all devices. The structure of FIG. 2 is exemplary.

The user interface 200 of FIG. 2 includes the following components: a cover layer 202; a capacitive sensor 203; a segmented optical shutter 204; a segmented electroluminescent device 205, a resistive switch layer 206; a substrate layer 207; and a tactile feedback layer 208. Additionally, a high-resolution display 209 and filler materials 210 may be included to complete the assembly. While the layers are shown individually, it will be clear to those of ordinary skill in the art having the benefit of this disclosure that some of the various layers may be combined together. For instance, the cover layer 202 and capacitive sensor 203 may be integrated together to form a single layer. Similarly, the tactile feedback layer 208 may be integrated into the cover layer 202, and so forth.

Starting from the top with the cover layer 202, a thin film sheet serves as a unitary fascia member for the device (100). A “fascia” is a covering or housing, which may or may not be detachable, for an electronic device like a mobile telephone. While the drawings herein employ a mobile telephone as an exemplary electronic device for discussion, it will be clear to those of ordinary skill in the art having the benefit of this disclosure that the invention is not so limited. The fascia of the present invention could be used for any electronic device having a display and a keypad, including gaming devices, personal digital assistants, pagers, radios, and portable computers.

The cover layer 202, in one exemplary embodiment, is a thin, flexible membrane. Suitable materials for manufacturing the thin, flexible membrane include clear or translucent plastic film, such as 0.4 millimeter, clear polycarbonate film. In another embodiment, the cover layer 202 is manufactured from a thin sheet of reinforced glass. The cover layer, being continuous and without holes or other apertures or perforations, is well suited to serve as a continuous fascia for the device (100), keeping dust, debris and liquids from invading the device. While the cover layer 202 is continuous, for discussion purposes, the cover layer 202 will be colloquially sectioned into a keypad region 106 and a display region 201. The keypad region 106 is the section of the cover layer 202 where user actuation targets, keys, and buttons will be presented, while the display region 201 is the section of the cover layer 202 where the high-resolution display 209 is visible.

To provide ornamentation, text, graphics, and other visual indicators, the cover layer 202, in one embodiment, includes printing disposed on the rear face 211. As will be described in more detail below, in one embodiment of the invention, the low-resolution display, i.e. the optical shutter layer 204, provides graphics and color for the front surface (105) of the device (100). However, even in such an embodiment, selective printing on the cover layer may be desirable. For instance, printing may be desired around the perimeter of the cover layer 202 to cover electrical traces connecting the various layers, or electrodes on certain layers. Additionally, printing of select demarcations 212 may be desirable. As will be described below, in one embodiment, when the device is off, the font surface (105) goes completely blank. Demarcations 212, which may be very light, small circles, provide the user with an indication of which portion of the front surface (105) is the keypad region 106, and which portion is the display region 201.

Printing may be desired on the front face 213 for various reasons as well. For example, a subtle textural printing or overlay printing may be desirable to provide a translucent matte finish atop the device (100). Such a finish is useful to prevent cosmetic blemishing from sharp objects or fingerprints. By printing only on the rear face 211, however, the front face 213 can remain smooth and glossy. When printing is done on the rear face 211 of the cover layer 202, the printing, being disposed on the inside of the device, is protected from wear and abrasion. There is generally no printing in the display region 201, so the high-resolution display 209 may be easily viewed. Printing about the display region 201 may be desired, however, for the reasons listed above.

The cover layer 202 may also include an ultra-violet barrier. Such a barrier is useful both in improving the visibility of the high-resolution display 209 and in protecting internal components of the device (100).

The user interface 200 of FIG. 2 also includes a capacitive sensor 203. The capacitive sensor 203, which is formed by depositing small capacitive plate electrodes on a substrate, is configured to detect the presence of an object, such as a user's finger, near to or touching the user interface 200. Control circuitry detects a change in the capacitance of a particular plate combination on the capacitive sensor 203. The capacitive sensor 203 may be used in a general mode, for instance to detect the general proximate position of an object relative to either the keypad region 106 or the display region 201. The capacitive sensor 203 may also be used in a specific mode, where a particular capacitor plate pair may be detected to detect the location of an object along length and width of the front surface (105) of the device (100). In this mode, the capacitive sensor 203 may be used to detect the proximate position of an object, such as a user's finger, relative to any of the actuation targets presented.

Turning to the segmented optical shutter 204, this layer is a segmented display device configured as an optical shutter. A “segmented” display device is used herein to mean a display device with less granularity than the pixilated display device referred to above. The segmented display device is capable of actuating a predefined segment or segments to open a shutter so as to present a predetermined text or symbol graphic to a user, but does not have sufficient granularity to easily transition from, for example, text to graphics. The segmented optical shutter 204 may be thought of as a low-resolution display. The term “low-resolution” is used herein to differentiate the segmented display device of the segmented optical shutter 204 from the high-resolution display 209. While the high-resolution display 209 is configured to actuate individual pixels to present high resolution text or images, the low-resolution display of the segmented optical shutter 204 uses electrodes placed atop and beneath the segmented optical shutter 204 to open and close “windows”, thereby transforming the window from a first, opaque state to a second, translucent state. The segmented optical shutter 204 is “segmented” because individual windows, or shutters, may be controlled. Further, as will be seen in more detail below, by configuring the electrodes on one side of the segmented optical shutter 204, each shutter can be configured as the alphanumeric indicia, which may include numbers, letters, or symbols forming images representative of graphics corresponding to a plurality of actuatable keys (the key itself is formed by the electroluminescent layer as will be described below).

The configuration presented from the plurality of keypad configurations may be mode-based. This means that the keypad configuration corresponds to a particular mode of operation of the device (100). For example, a camera mode may correspond to a camera keypad configuration, while a phone mode may correspond to an phone configuration. The segmented optical shutter 204 presents each of the plurality of keypad configurations by transitioning segments of the segmented optical shutter 204 from opaque states to translucent states. The segmented electroluminescent device 205 then creates a virtual key by projecting light both to illuminate the corresponding segment by projecting light through the segment, at a first luminosity, and about the segment—through the segmented optical shutter 204—at a second luminosity. The result is a reveal and concealment of each individual key, with corresponding alphanumeric characters or symbols appearing brighter than the key itself. Each key forms an actuation target that can be selected by the user.

The segmented electroluminescent device 205 includes segments that, in one embodiment, have a geometrically uniform shape. These segments of the segmented electroluminescent device 205 may be included to provide a backlighting function to create the user actuation targets. The user actuation targets may be configured in any number of ways, including in three columns and four rows as a twelve-digit telephone keypad.

As used herein, “electroluminescent” refers to any device capable of producing luminescence electrically, including light emitting diodes, and equivalent devices. In one embodiment, the segmented electroluminescent device 205 includes a layer of backlight material sandwiched between a transparent substrate bearing transparent electrodes on the top and bottom. The electrodes, which may be configured to be rectangles or ovals, reside beneath a corresponding shutter of the segmented optical shutter 204. In one embodiment, the electrodes are configures as ovals which project about the corresponding segments, i.e. they circumscribe the corresponding segments, by at least 0.5 millimeters so as to present a suitably visible user actuation target.

The high resolution display 209, which may have its own lighting system and may also include a polarizing layer 215 configured to polarize light along an axis of polarization, may be placed adjacent to the segmented optical shutter 204. Further, filler material 210 may be included to complete the assembly.

The resistive switch layer 206 includes a force switch array configured to detect contact with any of one of the shutters dynamic keypad region or any of the plurality of actuation targets. An “array” as used herein refers to a set of at least one switch. For instance, where the cover layer 202 is manufactured from glass, one switch may be all that is necessary. However, when the cover layer 202 is manufactured from thin film plastic, multiple switches may be employed. The array of resistive switches functions as a force-sensing layer, in that when contact is made with the front surface (105), changes in impedance of any of the switches may be detected. The array of switches may be any of resistance sensing switches, membrane switches, force-sensing switches such as piezoelectric switches, or other equivalent types of technology.

A substrate layer 207 is provided to carry the various control circuits and drivers for the layers of the display. The substrate layer 207, which may be either a rigid layer such as FR4 printed wiring board or a flexible layer such as copper traces printed on a flexible material such as Kapton®, can include electrical components, integrated circuits, processors, and associated circuitry to control the operation of the display. The substrate layer 207 includes a connector 214 for coupling to other electrical components within the device (100).

In one embodiment of the display assembly 200, for example where the cover layer 202 is manufactured from glass, a modicum of cover layer deflection is all that is required to actuate one of the keys presented by the segmented optical shutter 204 and the segmented electroluminescent device 205. This deflection can be on the order of tens of micrometers. As such, a user may not physically perceive any deflection at all when pressing each key.

To provide tactile feedback, an optional tactile feedback layer 208 may be included. The tactile feedback layer 208 may include a transducer configured to provide a sensory feedback when a switch on the resistive switch layer detects actuation of a key. In one embodiment, the transducer is a piezoelectric transducer configured to apply a mechanical “pop” to the user interface 200 that is strong enough to be detected by the user. Thus, the tactile feedback layer provides sensory feedback to the user, thereby making the smooth, substantially planar user interface 200 react like a conventional keypad without the need of individual popple-enabled keys protruding through the keypad.

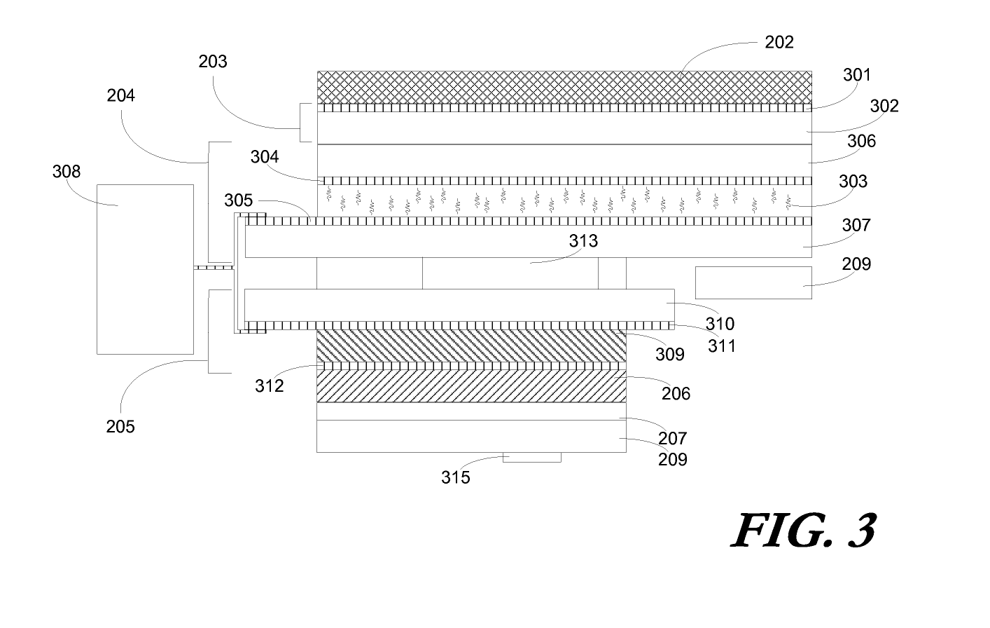

Turning now to FIG. 3, illustrated therein is a side view of the user interface (200) shown in FIG. 2. Each layer may be seen from the side in a cut-away view. Again, it will be clear to those of ordinary skill in the art having the benefit of this disclosure that the invention is not limited to the specific structure shown in FIG. 3. Some layers, as noted above, are optional and may not be included in certain applications.

Note that the layers may be coupled together in any of a variety of ways. One exemplary embodiment of a coupling mechanism is by using a thin layer of clear (transparent), non-conductive adhesive. For instance, the cover layer 202, the capacitive sensor 203, and the segmented optical shutter 204 may each be mechanically coupled together with non-conductive, translucent adhesive. This coupling keeps the overall assembly properly aligned within the device.

When viewing from the top, a user first sees the cover layer 202. Where glass is used for the cover layer 202, reinforced glass is often preferred to provide additional reliability to the user interface (200). The glass may be reinforced by a strengthening process, such as a chemical or heat treatment process.

Next, the capacitive sensor 203 may be seen. The capacitive sensor 203 includes both an electrode layer 301 and substrate layer 302. The substrate layer 302, which may be either rigid, or soft (for instance a silicone layer), carries the electrode plates that form the capacitive sensors. The electrodes may be used in a singular configuration, or in pairs. Further alternate electrode pairs, including electrode groupings of two, four, or six electrodes, may be used to form the capacitive sensors. The electrode layer 301, as will be described in more detail below, may be formed by printing solid indium-tin oxide (In.sub.2 O.sub.3—SnO.sub.2) in the desired capacitor plate patterns atop the substrate layer 302. Other materials, including patterned conductive inks, may also utilized in the electrode construction.

Next, the segmented optical shutter 204 may be seen. In one embodiment, the segmented optical shutter 204 is manufactured using a twisted nematic liquid crystal display material. This material is discussed herein as an exemplary embodiment. However, it will be clear to those of ordinary skill in the art having the benefit of this disclosure that the invention is not so limited. Other materials, including polymer-dispersed liquid crystal material, super twisted nematic liquid crystal material, ferro-electric liquid crystal material, electrically-controlled birefringent material, optically-compensated bend mode material, guest-host materials, and other types of light modulating may equally be used.

The segmented optical shutter 204 is made from a twisted nematic liquid crystal display material 303 that is sandwiched between two electrodes 304,305 and two substrates 306,307. The electrodes 304,305 and substrates 306,307 are preferably transparent, such that light can pass freely through each. The substrates 306,307 may be manufactured from either plastic or glass. The upper electrode 304 is constructed, in one embodiment using indium-tin oxide affixed to substrate 306. The lower electrode 305 is constructed using a patterned indium-tin oxide layer affixed to the lower substrate 307. In one embodiment, the patterns are those of alphanumeric keys or symbols representing keys or user actuation targets of the device. The patterned electrode(s) 305, by way of patterned electrical traces, is connected to a control circuit 308. The control circuit 308 applies a field to the patterned electrode(s) 305, while the other electrode 304 acts as a ground. The direction of the electric field is not important to the segmented optical shutter 204, thus either electrode can act as the ground.

The electric field applied alters the light transmission properties of the twisted nematic liquid crystal display material 303. The electric field can cause sections under each of the patterned electrodes 305 to transition from a first state to a second state. By way of example, the first state may be opaque, while the second state is translucent. The patterns of the patterned electrodes 305 define the images of each shutter in the optical shutter. By way of example, a shutter can be patterned as a “9 key” for a phone by patterning one electrode as the “9 wxyz” characters. The shutters thus act as “windows” that can be open or closed, to reveal or hide images.

The segmented optical shutter 204 may also include one or more polarizing layers disposed atop and beneath the optical shutter. These polarizing layers, which are used in twisted nematic liquid crystal devices as will be shown below, polarize light along a polarization axis.

The segmented electroluminescent device 205 includes a layer of electroluminescent material 309 sandwiched between a transparent substrate 310. The transparent substrate 310 is patterned with indium tin oxide electrodes, each forming the actuator for an electroluminescent element. The electroluminescent elements are positioned beneath a corresponding segment of the segmented optical shutter 204, with each electroluminescent element being larger than the corresponding segmented optical shutter segment. The plurality of patterned electrodes 311 of the segmented electroluminescent device 205 are aligned with the various shutters of the segmented optical shutter 204, generally on a one-to-one basis. In such an embodiment, the ground electrode 312 may comprise a solid conductive ink layer printed on the bottom surface of the electroluminescent material 309; however, the ground electrode 312 may be patterned and may be borne on a transparent or non-transparent substrate if desired. One electrode layer 301 is connected to control circuitry 308. Like the segmented optical shutter 204, either electrode layer 311,312 can act as the ground. Each electroluminescent element is active when the corresponding segmented optical shutter segment is in a translucent state.

In one embodiment, the segmented electroluminescent device 205 may further include a transflector layer. The transflector layer, which is a semi-transparent material configured to both reflect light and pass light, permits the operation of the device (100) in a transflexive mode. In the transflexive mode, when any shutter of the segmented optical shutter 204 opens, incident light passes through the shutter, reflects off the transflector layer, and is passes back to the user. This action makes the alphanumeric indicia of the segmented optical shutter layer visible in bright light conditions. When the segmented electroluminescent device 205 is operational, which may be dictated by an ambient light sensor, the transflector passes light from the electroluminescent device through the open shutters so as to form an actuation target that includes both the alphanumeric indicia and the virtual key created by the projection of light through the segmented optical shutter 204. This action makes the actuation targets visible in low light conditions.

An optional color layer 313 may be included atop the segmented optical shutter 204 having one or more colors. The color layer 313, which may also be a transflector having both transmission and reflection properties, may be used to color light coming from the segmented optical shutter 204. The color layer 313 may alternatively be made of color filters, which only have transmission properties.

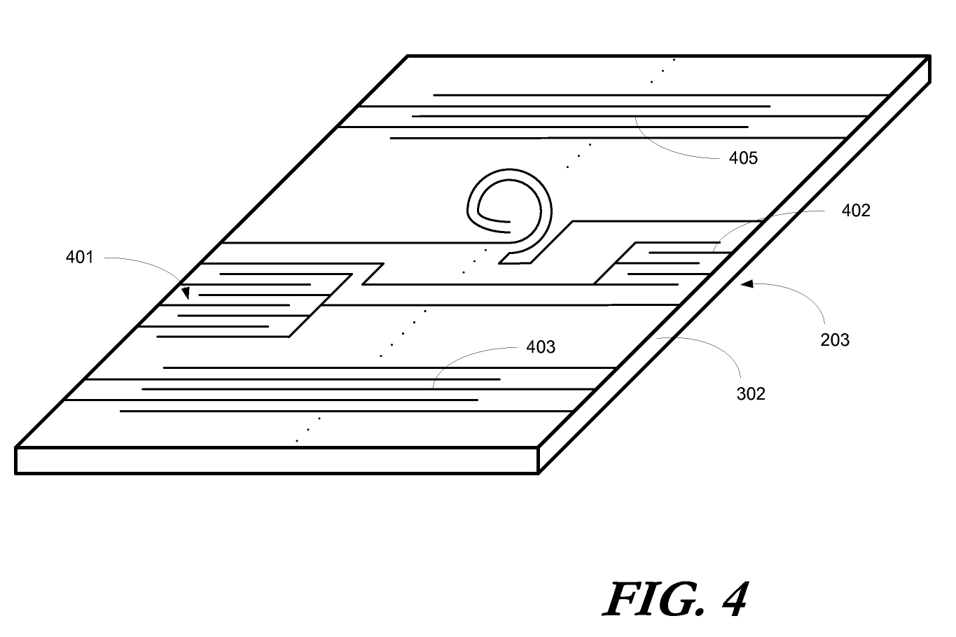

Turning now to FIG. 4, illustrated therein is a more detailed view of the optional capacitive sensor 203. The capacitive sensor 203 includes a plurality of capacitive sensing devices 401,402,403,404 disposed along a substrate 306. The capacitive sensing devices 401,402,403,404 may be disposed both beneath the keypad region (106) and about the display region (201). Each capacitive sensing device 401,402,403,404 is configured, in conjunction with associated control circuitry (not shown) to detect an object in close proximity with—or touching—the portable electronic device (100).

The capacitive sensing devices 401,402,403,404 in one embodiment are formed by disposing indium tin oxide atop the substrate 306. Indium tin oxide is a mixture of indium oxide and tin oxide. It is transparent and conductive, and is capable of being deposited in thin layers by way of a printing process. Indium tin oxide is well suited for the present invention due to its combination of electrical conduction properties and optical transparency. The capacitive sensing devices 401,402,403,404 may be deposited on the substrate by electron beam evaporation, physical vapor deposition, or other various sputter deposition techniques.

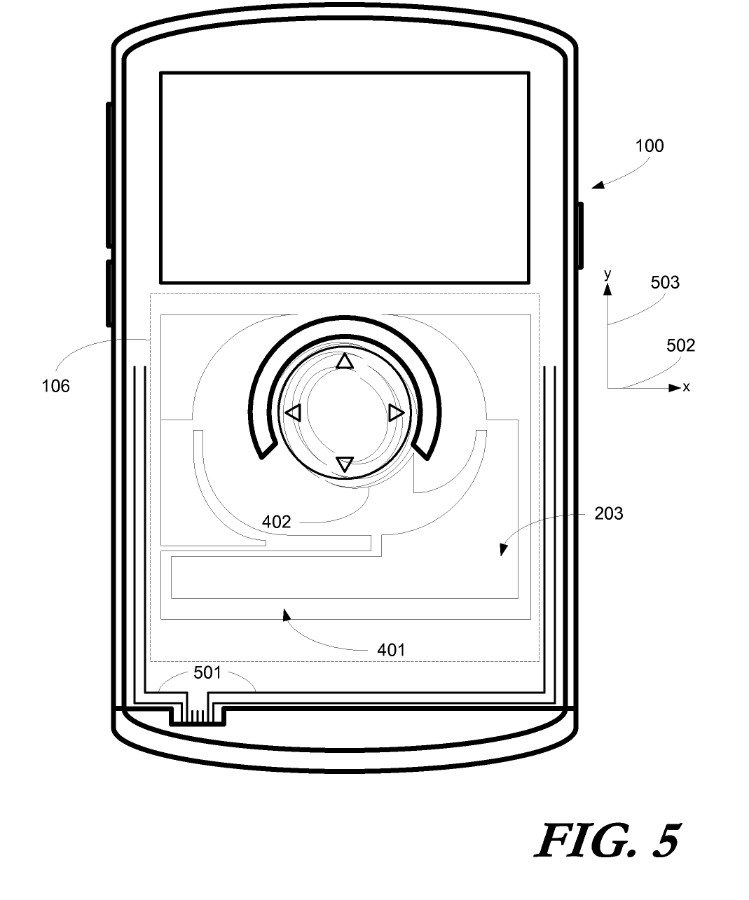

Turning now to FIG. 5, illustrated therein is an operational view of the capacitive sensor 203. The various capacitor electrodes, e.g. 401,402, may be seen to detect the proximity of an object near the keypad region 106. Various electrical leads 501 connect the capacitive sensing devices 401,402 to control circuitry. The capacitive electrodes 401,402 function as a proximity detection device configured to detect objects proximately located with the user interface. When an object comes into near or into contact with the device 100, the capacitance of one of the capacitive sensing devices near the object changes. The control circuitry detects this change and alerts processing circuitry within the device 100.

This proximity detection may be used for a variety of functions. As noted above, the proximity detection may be used to detect the position of the object in the x and y directions 502,503. Thus is useful when the cover layer (202) is made from a rigid material, such as glass. Further, the proximity detection may be used to transition the device 100 from a first mode to a second mode. By way of example, when the device is either OFF or in a low power state, a user may wake the device by touching the front surface (105) of the device 100. The proximity detection, detecting the user's finger, may cause the device 100 to wake from the low power state. This waking may include causing the segmented optical shutter (204) to present a keypad configuration associated with a default or previous mode.

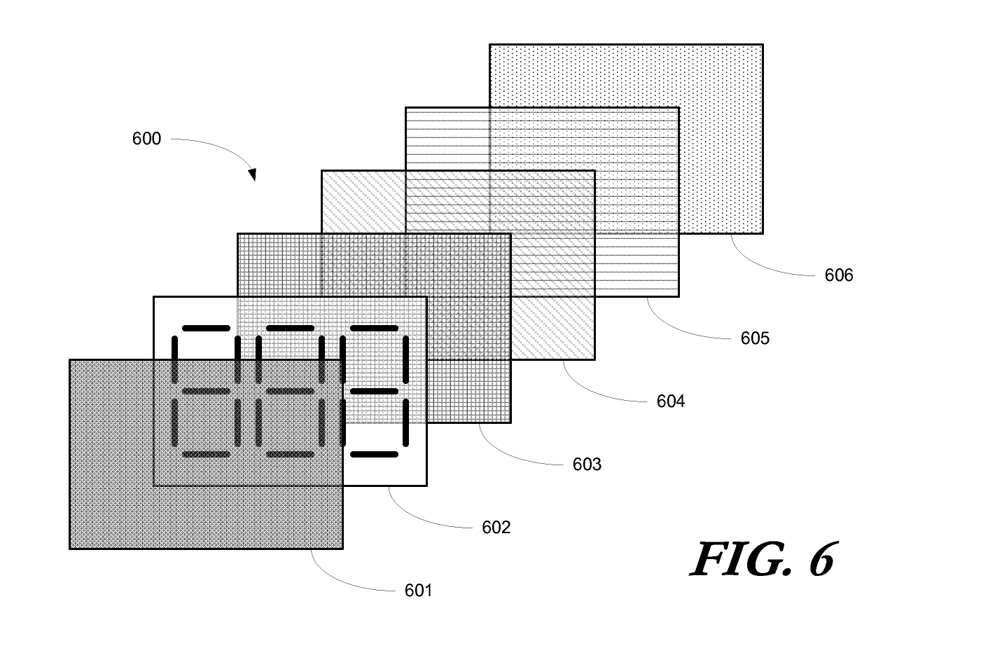

Turning now to FIG. 6, illustrated therein is an exploded view of a twisted nematic liquid crystal display device 600. The device 600, which in one embodiment is used to form the segmented optical shutter (204), is referred to as “twisted” because it contains liquid crystal elements that twist and untwist in differing amounts to allow light to pass through.

A first polarizer 601 is disposed on one side of the device to polarize incident light. A substrate 602, having indium tin oxide electrodes (as previously discussed) printed in varying shapes is disposed adjacent to the polarizer. The electrodes may be disposed in shapes that correspond to the alphanumeric indicia or symbols associated with the keys of the electronic device (100).

Twisted nematic liquid crystal material 603 is then next, followed by another substrate 604 configured with ground electrodes. A horizontal filter 605 then is used to permit and block light. A reflective or transflective surface 606 then reflects light back (in a reflective mode) or transmits light in a transflective mode. The reflective or transflective surface 606 is optional and will depend upon the particular application. When the twisted nematic liquid crystal device is used as an optical shutter, the reflective or transflective surface 606 may not be employed.

Where no voltage is applied to the electrodes, the device is in a first state. When voltage is applied the liquid crystal material twists—in incremental amounts up to 90 degrees—thereby changing the luminous polarization. This liquid crystal thus acts as a controllable polarizer, controlled by electrical signals applied to the electrodes. Adjustment of the voltage being applied to the electrodes permits varying levels grey, as well as transparent states or opaque states to be created.

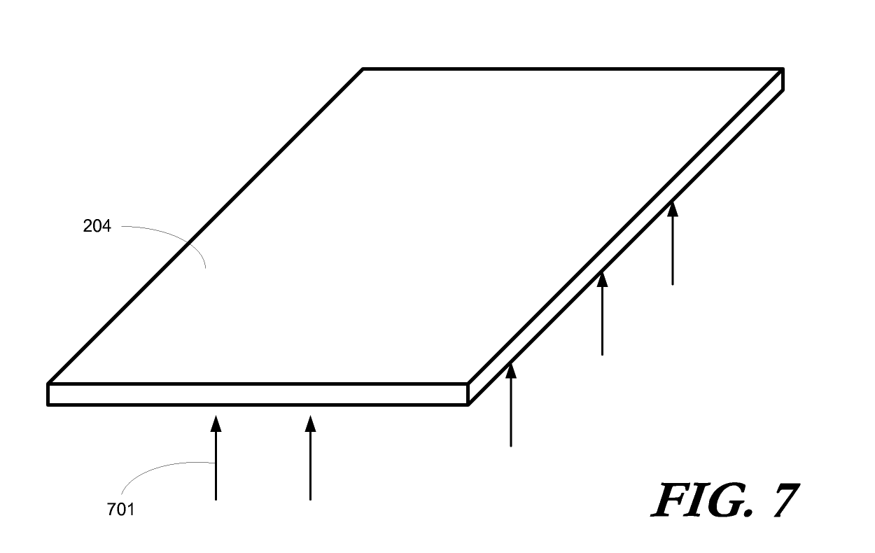

Turning now to FIG. 7, illustrated therein is the segmented optical shutter 204 in an opaque state. Incident light 701 is not permitted to pass through the optical shutter, as the liquid crystal material is twisted, relative to the polarizers, so as to block light from passing through.

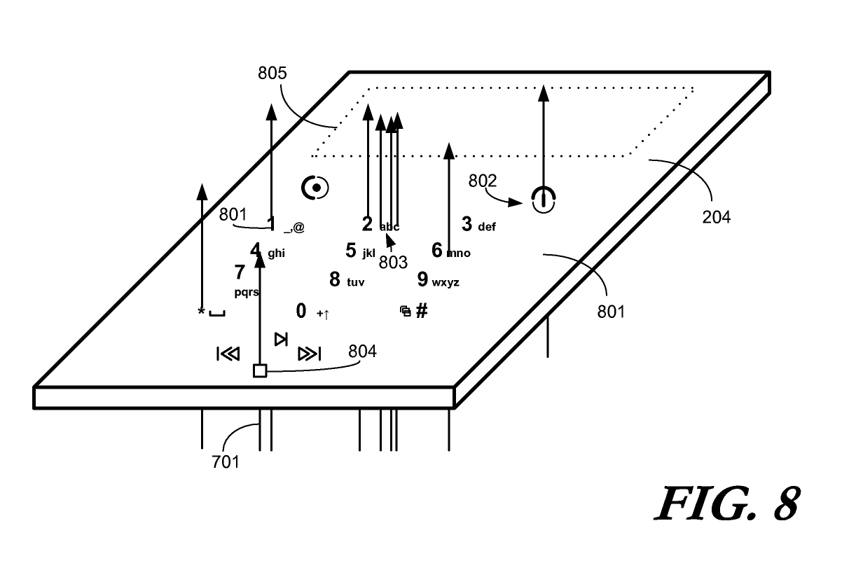

Turning now FIG. 8, illustrated therein is the segmented optical shutter 204 when various exemplary shutters 801,802,803,804 have been transitioned from the opaque state to the translucent state. Control circuitry, which may be disposed on the substrate layer (207), is configured to selectively actuate at least one shutter or cell, perhaps based upon a current operational mode of the device (100), to transform the shutter from a first cell state to a second cell state.

Each shutter, which acts as a segment within the segmented optical shutter 204, corresponds to a key or a particular window (such as a window 805 above the high resolution display (209)), such that when any of the segments is actuated, corresponding key indicia becomes visible to a user. Incident light, e.g. ray 701, passes through the shutters 801,802,803,804, thereby making the shape of the shutter visible. By way of example, where the device (100) includes an segmented optical shutter (204), light from the electroluminescent device may project through the shutters 801,802,803,804 when they are open. This would be operation in a transmissive mode.

The exemplary shutters 801,802,803,804 of FIG. 8 have been geometrically configured as a particular key symbol for the portable electronic device. These keys and symbols are exemplary only, as it will be clear to those of ordinary skill in the art having the benefit of this disclosure that many different shapes and sizes may be used as key symbols. Each shutter 801,802,803,804 forms a user actuation target when in the transparent state.

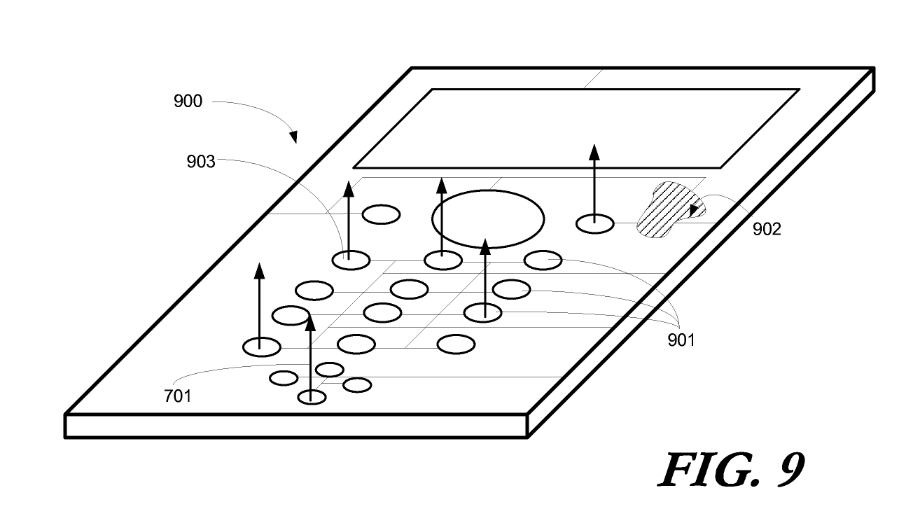

Turning now to FIG. 9, illustrated therein is one embodiment of a segmented electroluminescent device 205 in accordance with embodiments of the invention. The segmented electroluminescent device 205 includes patterned electrodes 901 that are positioned to correspond to the shutters of the segmented optical shutter (204). The patterned electrodes 901 are formed, in one embodiment, by depositing translucent electrode material (such as indium-tin oxide) along an electroluminescently active substrate. The patterned electrodes 901, together, serve as a plurality of electroluminescent elements, each of which may be selectively actuated. In other words, when the each shutter is actuated to transition from an opaque state to a translucent state, a corresponding patterned electrode, and thus a corresponding electroluminescent cell, is actuated so as to project light through the actuated segment.

In one embodiment, the patterned electrodes 901 are configured so as to have a geometrically uniform, predetermined shape. The exemplary patterned electrodes 901 of FIG. 9 are oval in shape. It will be clear to those of ordinary skill in the art having the benefit of this disclosure that the invention is not so limited. Other shapes, including rectangles, squares, diamonds, or circles, may also be used.

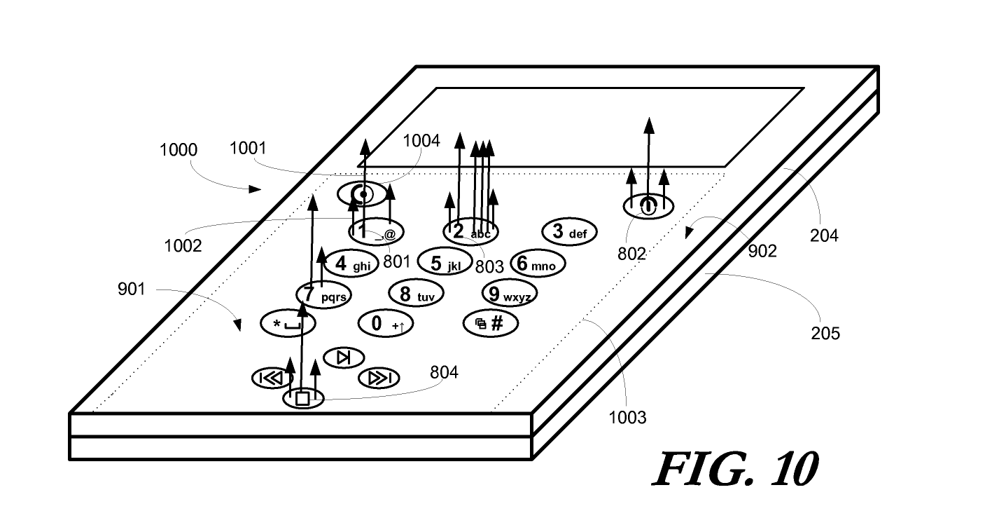

The segmented optical shutter (204), in some embodiments, is not a perfect absorber of light. It rather acts as a semi-translucent material through which some small amount of light may pass. When the patterned electrodes 901 are on, they project light not only through the segments (801,802,803,804), but also through the optical shutter material itself. Light passing through the optical shutter material is mostly absorbed, but some light passes through. When the patterned electrodes 901 are larger than their corresponding shutter, light passes through the shutter with a first luminous intensity and through the optical shutter material with a second luminous intensity that is less than the first. The result is a “halo” effect about the shutter, with the shutter forming key indicia and the halo forming the key perimeter. In effect, the light from the patterned electrodes 901 project both through the corresponding shutter or segment and circumscribe the corresponding shutter or segment to form a user actuation target. This will be described in more detail with the discussion of FIG. 10.

The segmented electroluminescent device 205 may also include a reflective or transflective layer 902 coupled thereto. For instance, the reflective layer 902 may be disposed on the top of the segmented electroluminescent device 205. In addition to using electro luminescent materials for the segmented electroluminescent device 205, other materials, including light emitting diode arrays, plasma panels, vacuum florescent panels, organic or polymeric light emitting diode panels, or other light source materials may also be used.

Turning now to FIG. 10, illustrated therein is a dynamic user interface 1000 for an electronic device. The dynamic user interface 1000 includes a segmented optical shutter 204 and an segmented optical shutter 204 having a plurality of patterned electrodes (901) disposed thereon. The segmented optical shutter 204 and segmented optical shutter 204, in one embodiment, may be coupled together by way of a translucent, non-conductive adhesive. The segmented optical shutter 204 is configured to present one of a plurality of keypad configurations by transitioning segments 801,802,803,804 from opaque states to translucent states. These keypad configurations are presented in a keypad region 1003 of the portable electronic device into which the dynamic user interface 1000 is inserted.

Each of the patterned electrodes (901) is positioned beneath a corresponding segment 801,802,803,804, and is configured to be larger than the corresponding segment 801,802,803,804. The patterned electrodes (901), in one embodiment, are geometrically configured to represent key boundaries, and as such, may be configured as squares or ovals (ovals are shown in FIG. 9). Further, in such an embodiment the segments 801,802,803,804 may be configured as alphanumeric key indicia, symbols, or combinations thereof. As such, each electroluminescent element—where for instance the electroluminescent element was oval—would be different from any shape of the segments.

In one embodiment, each patterned electrode is active only when the corresponding segment is active. In other words, the electroluminescent element projects light only when the shutter positioned above the electroluminescent is open. When this occurs, the active patterned electrode illuminates the corresponding segment by projecting light both through the corresponding segment and about the corresponding segment—through the optical shutter material—so as to circumscribe the segment.

The circumscription of the segment, combined with the illuminated segment, forms a composite user actuation target that may be hidden from or revealed to a user. Where the segment is geometrically configured as key indicia, such as that for a portable telephone, the key indicia and the visible circumscription 1004 of the key indicia forms the composite actuation target. The keypad region 1003 thus becomes a “dynamic” keypad region as user actuation targets may be selectively presented or removed. For example, when the device is in a telephone mode, the dynamic keypad region may be that of a twelve-character telephone keypad. When in an alternate mode, some or all of the twelve character keys may be hidden.

By way of example, segment 801 is positioned above a corresponding electroluminescent element (which would be electroluminescent element 903 in FIG. 9). When segment 801 is open, the electroluminescent element (903) projects light 1001 through the segment 801 at a first luminosity. The electroluminescent element (903) then also projects light 1002 through the semi-translucent material of the segmented optical shutter 204, to circumscribe segment 801 with an oval, with a light 1002 of a second luminosity. In one embodiment, this circumscription 1004 circumscribes the corresponding segment 801 as an oval by at least 0.5 millimeters so as to be easily visible to a user. As represented by the arrows shown in the exemplary embodiment of FIG. 10, the luminosity associated with light 1001 is greater than the luminosity associated with light 1002.

The activation of the shutters or the corresponding electroluminescent elements may occur in response to control circuitry coupled to the capacitive sensor (203), which serves as a proximity detector. By way of example, the control circuit may be responsive to the capacitive sensor (203) such that when an object comes within a predetermined distance of the segmented optical shutter 204, the control circuitry causes at least one of the segments and corresponding electroluminescent elements to come on. This means that the segment opens and the corresponding electroluminescent element transitions from a non-illuminated state to an illuminated state.

So as to provide a user interface that does not significantly increase user cognitive loading, in one embodiment each of the segments 801,802,803,804 is physically separated from each other segment. Specifically, each segment is physically separated from other segments by the semi-translucent material of the segmented optical shutter 204. Similarly, each electroluminescent element of the segmented optical shutter 204 is physically separated from other electroluminescent elements. In one embodiment, the electroluminescent elements are spaced from each other by a distance of at least 0.4 millimeters.

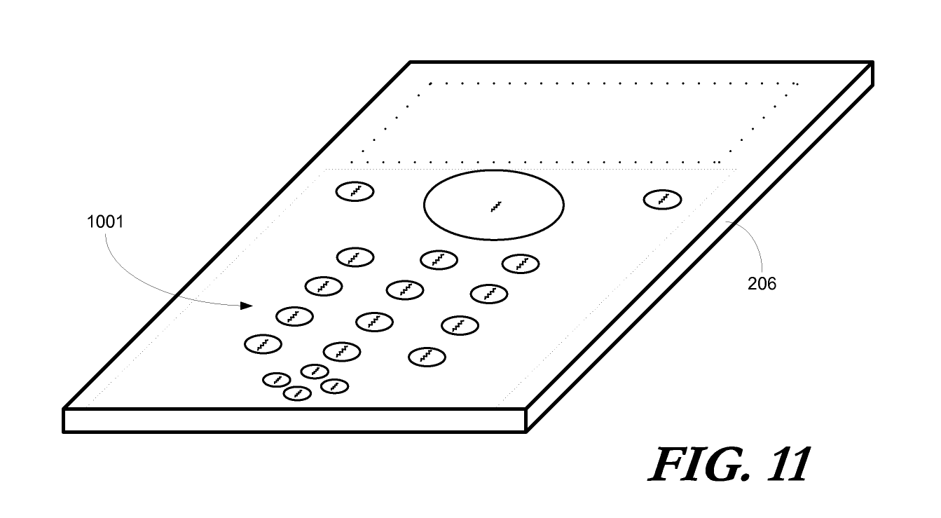

Turning now to FIG. 11, illustrated therein is the resistive switch layer 206 in accordance with embodiments of the invention. The resistive switch layer 206 operates as a resistance-sensing layer, or a force sensor, to detect when a user actuates one of the user actuation targets presented by the segmented optical shutter (204) working in conjunction with the segmented optical shutter (204). In the view of FIG. 11, the array 1101 of resistance switches may be seen. In one embodiment, the resistive switch layer 206 is disposed beneath the segmented optical shutter (204) and the segmented optical shutter (204).

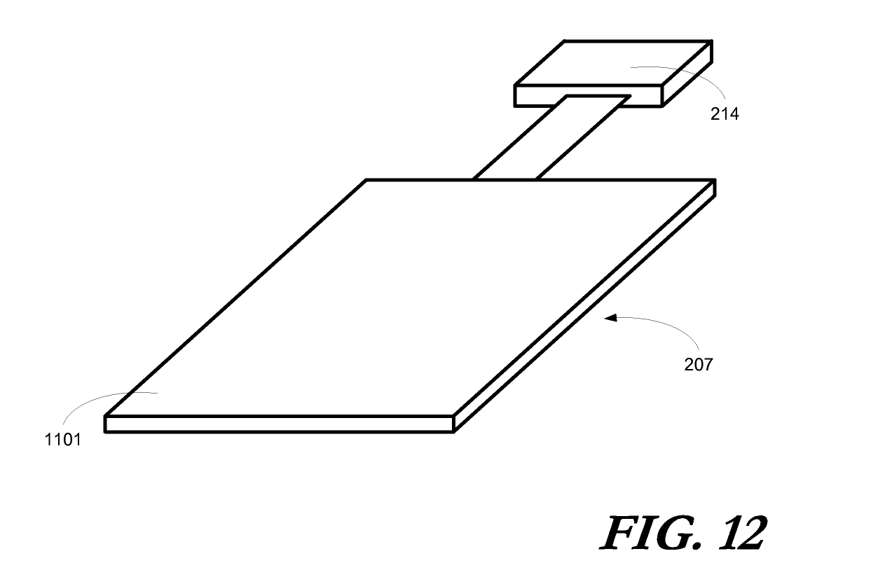

Turning now to FIG. 12, illustrated therein is one embodiment of the substrate layer 207 in accordance with the invention. The substrate layer 207 includes a rigid or flexible substrate 1101 that has copper traces disposed thereon. The copper traces electrically couple control circuitry (not shown) to the flexible substrate 1101. The electrical traces extend to a connector 214 that may be connected to other circuitry or components within the device. In one embodiment, the flexible substrate 1101 and control circuit combine to form a circuit substrate assembly that is electrically coupled to the segmented optical shutter (204), the segmented optical shutter (204), the capacitive sensor (203), and the resistive switch layer (206). This control circuitry is used to control the operation of these devices. By way of example, using the segmented optical shutter (204), the control circuitry may be configured to selectively actuate one or more segments of the electroluminescent device, thereby causing the at least one segment to transform from a first, non-illuminated state to a second, illuminated state.

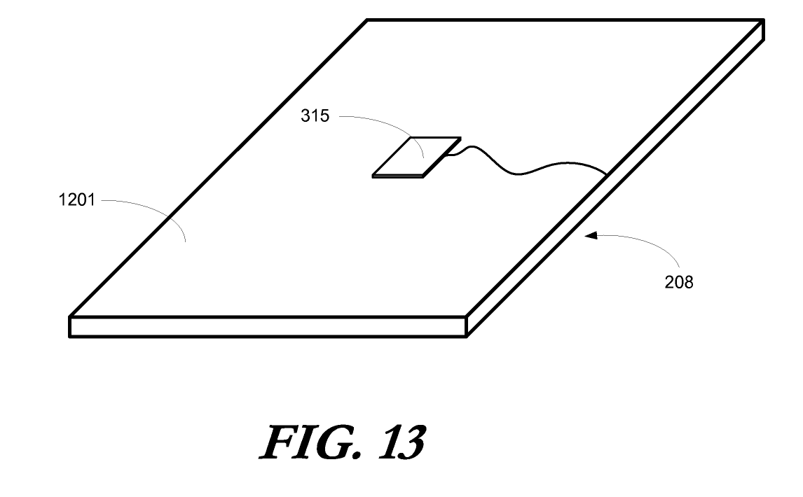

Turning now to FIG. 13, illustrated therein is one embodiment of the tactile feedback layer 208 in accordance with the invention. As mentioned above, the smooth front surface (105) of the device, in one embodiment, includes no popple-type buttons protruding through. Thus, there is nothing for the user to physically press when actuating a key. To simulate the response of a popple-type button, one embodiment of the present invention includes a tactile feedback layer 208. The tactile feedback layer 208 includes a transducer 315 to deliver a feedback sensation to the user indicating that a key has been successfully actuated. The tactile feedback layer 208, in one embodiment, is disposed beneath the resistive switch layer (206).

The tactile feedback layer 208 may be manufactured in one of a variety of ways. One exemplary embodiment of the tactile feedback layer 208 is one where a metal plate 1201 has at least one piezoelectric transducer 315 coupled thereto. A control circuit coupled to one of the capacitive sensor (203) or the resistive switch layer (206) is used to drive the transducer 315. When a key signal is received from either the capacitive sensor (203) or the resistor switch layer, the control circuit actuates the transducer 315. This actuation causes the metal plate 1201 to move or slightly deflect, thereby providing a tactile feedback to the user.

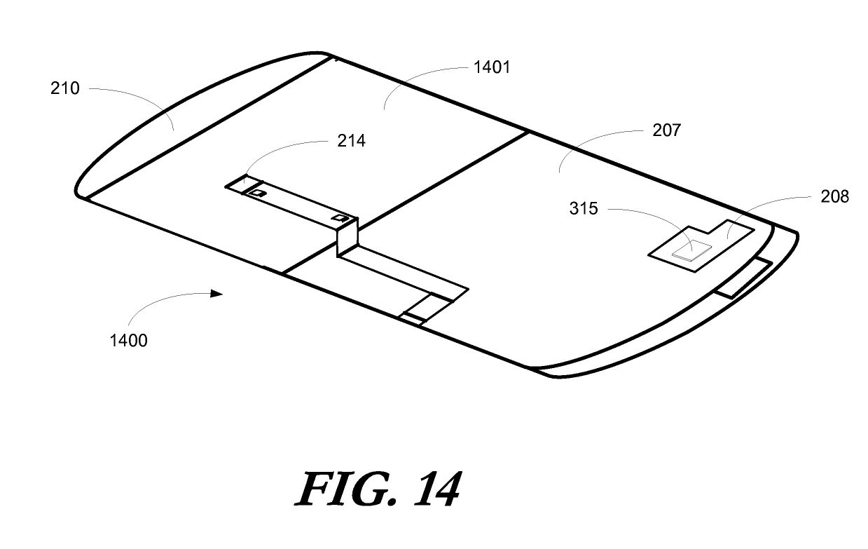

Turning now to FIG. 14, illustrated therein is an assembled user interface device 1400 in accordance with embodiments of the invention. From this rear, perspective view, some of the bottom components can be seen. A void 1401 may be seen adjacent to the substrate layer 207. This void is for receiving the high-resolution display (209) when the user interface device 1400 is coupled to the electronic device (100). Note that the high-resolution display (209) may optionally be coupled directly to the user interface device 1400 prior to coupling the user interface device 1400 to the electronic device (100). However, alignment of the high-resolution display (209) may be more easily facilitated by connecting the high-resolution display (209) to the electronic device first.

Filler material 210 has been also positioned adjacent to the void 1401 to assist in holding the assembly in proper alignment within the electronic device (100). The connector 214, coupled to the substrate layer 207, may be coupled to the electronic device (100), thereby electrically connecting the user interface device 1400 to the other electrical circuitry in the electronic device (100).

As may be seen from the view of FIG. 14, the tactile feedback layer 208 has been reduced to a small plate that is coupled to the substrate layer 207. This reduction in size offers increased protection to the electrical components that are coupled to the substrate layer 207. The transducer 315 on the tactile feedback layer 208 is cable of moving the tactile feedback layer 208 sufficiently for a user to feel the response to a key actuation.

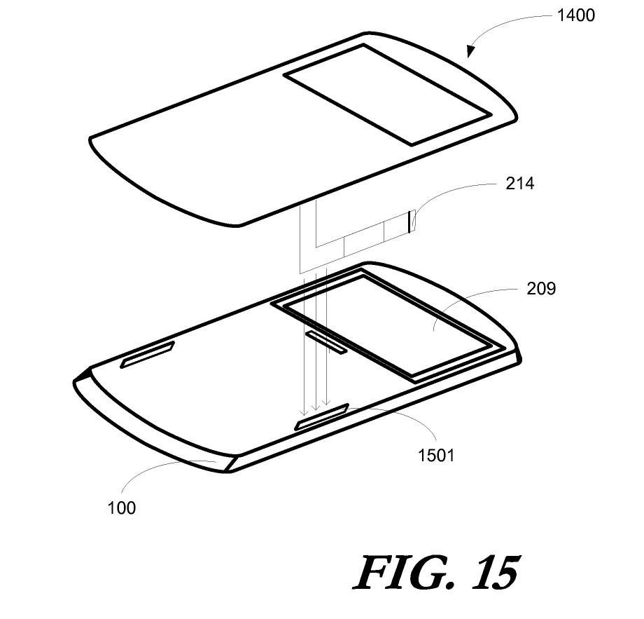

Turning now to FIG. 15, illustrated therein is the user interface device 1400 being coupled to the electronic device 100. In one embodiment, the portable electronic device 100 comprises a radiotelephone. From this exploded view, the high-resolution display 209, which may have a layer of clear, non-conductive adhesive disposed thereon, may be seen. The high-resolution display 209 sits within the void (1401) shown in FIG. 14. The connector 214 fits within a connector receptacle 1501 of the electronic device, thereby permitting an electrical connection between the user interface device 1400 and the other components and circuits of the electronic device 100.

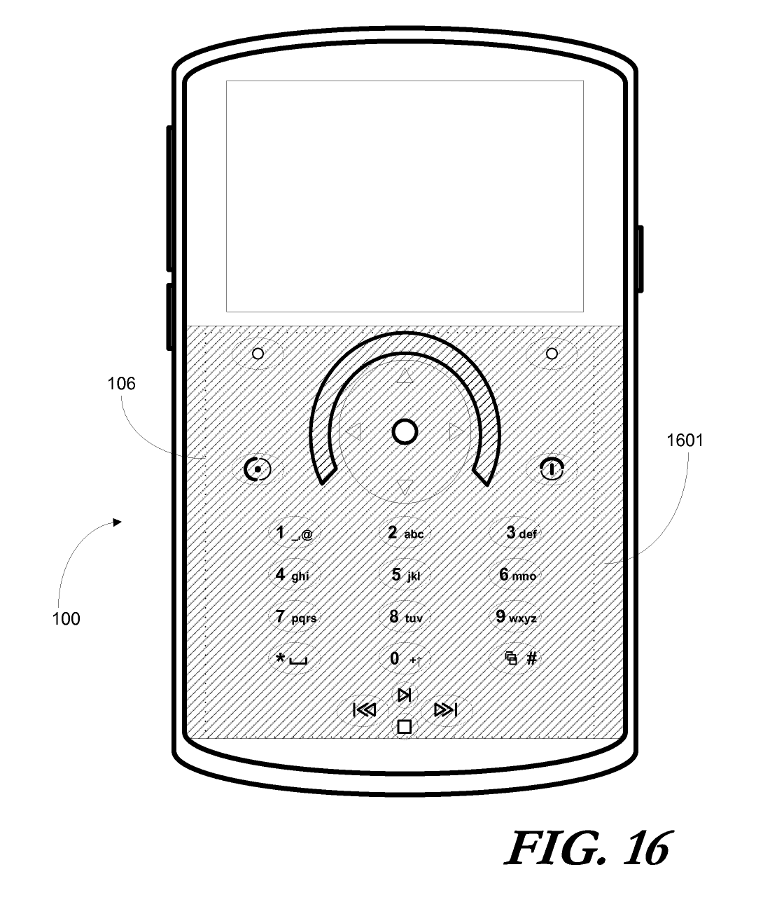

Turning now to FIG. 16, illustrated therein is the completed electronic device 100 having a user interface in accordance with one embodiment of the invention. From the view of FIG. 16, the area 1601 where the resistive switch layer (206) is configured to sense a key actuation is shown. The electronic device 100 of FIG. 16 employs a thin, flexible plastic as the cover layer (202). As such, the resistive switch layer (206) is configured to sense key actuation only along the keypad region 106. Note that if the cover layer (202) used glass as a material of manufacture, the resistive switch layer (206) may be able to detect only general key actuations. In such an embodiment, internal control circuitry would rely upon the capacitive sensor (203) to determine the location of the user's finger.

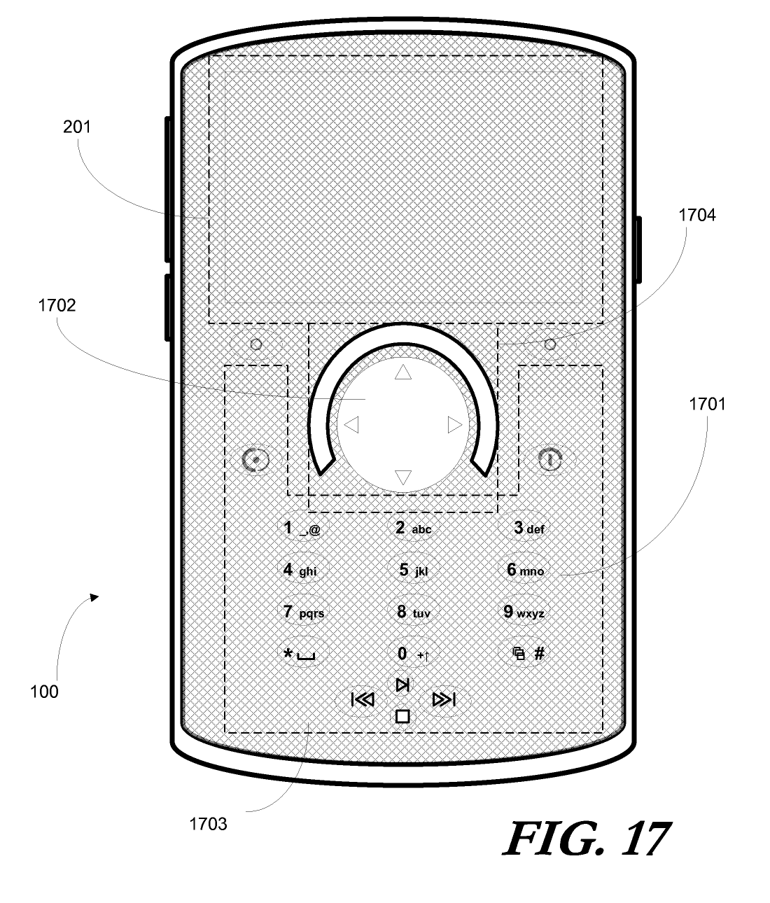

FIG. 17 illustrates the area 1701 in which the capacitive sensor (203) is active, in accordance with one embodiment of the invention. In the embodiment of FIG. 17, the entire front surface 105 of the device 100 is configured to respond to the proximity detection of the capacitive sensor (203). This includes the area underneath the navigation wheel 1702, which may be used as a key for selection of the alternate modes of the device 100. Proximity with each of a display region 201, a keypad region 1703, and a navigation region 1704 may be sensed by the capacitive sensor (203). The keypad region 1703 of FIG. 17 is sometimes referred to as the “low-resolution key area” of the device 100.

By having the area 1701 in which the capacitive sensor (203) is active disposed across the front surface 105 of the device 100, the capacitive sensor may be configured to actuate the segmented optical shutter (204) upon the object coming in close proximity with (or touching) the front surface of the portable electronic device 100. When this occurs control circuitry coupled to each of the capacitive sensor (203) and the segmented optical shutter (204) may be configured to cause at least one segment or window of the segmented optical shutter (204) to transition to the translucent state. This transition may be used to indicate a change from a low-power mode, or to present one of a plurality of keypad configurations along the keypad region 1703.

In the foregoing specification, specific embodiments of the present invention have been described. However, one of ordinary skill in the art appreciates that various modifications and changes can be made without departing from the scope of the present invention as set forth in the claims below. Thus, while preferred embodiments of the invention have been illustrated and described, it is clear that the invention is not so limited. Numerous modifications, changes, variations, substitutions, and equivalents will occur to those skilled in the art without departing from the spirit and scope of the present invention as defined by the following claims. Accordingly, the specification and figures are to be regarded in an illustrative rather than a restrictive sense, and all such modifications are intended to be included within the scope of present invention.

What is claimed is:

1. A dynamic user interface for an electronic device, comprising:
a segmented optical shutter configured to present one of a plurality of keypad configurations by transitioning segments of the segmented optical shutter from opaque states to translucent states; and
a plurality of electroluminescent elements, each electroluminescent element being positioned beneath a corresponding segment of the segmented optical shutter, wherein each electroluminescent element is larger than the corresponding segment;
wherein each electroluminescent element is active only when the corresponding segment is in a translucent state; and
further wherein each electroluminescent element, when active, projects light both to illuminate the corresponding segment by projecting light through the corresponding segment and to circumscribe the corresponding segment by projecting light through the segmented optical shutter about the corresponding segment.

2. The dynamic user interface of claim 1, wherein each of the plurality of electroluminescent elements has a geometrically uniform, predetermined shape.

3. The dynamic user interface of claim 2, wherein the geometrically uniform, predetermined shape comprises one of a rectangle or an oval.

4. The dynamic user interface of claim 3, wherein the geometrically uniform, predetermined shape comprises the oval, wherein the oval circumscribes the corresponding segment by at least 0.5 millimeters.

5. The dynamic user interface of claim 1, wherein each electroluminescent element is separated from each other electroluminescent element by at least 0.4 millimeters.

6. The dynamic user interface of claim 1, wherein each segment of the segmented optical shutter is geometrically configured as key indicia.

7. The dynamic user interface of claim 6, wherein each of the plurality of keypad configurations comprises a plurality of actuation targets, wherein each actuation target comprises a combination of the key indicia and a visible circumscription of the key indicia.

8. The dynamic user interface of claim 7, wherein one of the plurality of keypad configurations comprises a twelve-character telephone keypad.

9. The dynamic user interface of claim 6, wherein the key indicia is one of an alphanumeric key, a predetermined symbol key, or combinations thereof.

10. The dynamic user interface of claim 1, wherein the plurality of electroluminescent elements comprises a plurality of selectively operable, translucent electrodes coupled to an electroluminescent substrate.

11. The dynamic user interface of claim 10, wherein the electroluminescent substrate is mechanically coupled to the segmented optical shutter by translucent, non-conductive adhesive.

12. The dynamic user interface of claim 1, further comprising control circuitry electrically coupled to the plurality of electroluminescent elements, wherein the control circuitry is configured to selectively actuate at least one electroluminescent device, thereby causing the at least one electroluminescent device to transform from a non-illuminated to an illuminated state.

13. The dynamic user interface of claim 12, further comprising a capacitive sensor configured to detect proximate position of an object relative to the segmented optical shutter, wherein the control circuitry is responsive to the capacitive sensor such that when the object comes within a predetermined distance of the segmented optical shutter, the control circuitry causes the at least one electroluminescent device to transform to the illuminated state.

14. The dynamic user interface of claim 13, further comprising a force switch array configured to detect contact of the object with a surface of the dynamic user interface.

15. The dynamic user interface of claim 1, wherein a shape of each of the plurality of electroluminescent elements is different from any shape of the segments.

16. A portable electronic device having a user interface comprising a dynamic keypad region, the dynamic keypad region comprising:
a segmented optical shutter configured to a plurality of user actuation targets by by transitioning segments of the segmented optical shutter from opaque states to translucent states, wherein each segment is physically separated from another by semi-translucent material; and
a luminescent device disposed beneath the segmented optical shutter, wherein the luminescent device is configured to project light both through at least one segment of the segmented optical shutter when the at least one segment is in a translucent state to illuminate the at least one segment with light of a first luminosity and about the at least one segment, through the semi-translucent material, to circumscribe the at least one segment with light of a second luminosity.

17. The portable electronic device of claim 16, wherein the first luminosity is greater than the second luminosity.

18. The portable electronic device of claim 16, wherein the luminescent device comprises a plurality of translucent, uniformly shaped electrodes disposed thereon.

19. The portable electronic device of claim 18, wherein each translucent, uniformly shaped electrode is geometrically configured as an oval.

20. The portable electronic device of claim 19, wherein the portable electronic device comprises a radiotelephone, further wherein the plurality of translucent, uniformly shaped electrodes comprises at least twelve electrodes configured in three columns with four electrodes in each column.
